(19) United States
(12) Patent Application Publication
(10) Pub. No.: US 2017/0032310 A1
(43) Pub. Date: Feb. 2, 2017

(54) INVENTORY MANAGEMENT AND MARKETPLACE

(71) Applicant: Charles Mimnaugh, Salt Lake City, UT (US)

(72) Inventor: Charles Mimnaugh, Salt Lake City, UT (US)

(21) Appl. No.: 14/811,273

(22) Filed: Jul. 28, 2015

(51) Int. Cl. G06Q 10/08; G06F 17/24

(52) U.S. Cl. CPC G06Q 10/087; G06F 17/243

(57) ABSTRACT

Systems and methods for providing inventory management and a marketplace. The disclosed embodiments provide a visual presentation of a set of inventory items organized using a loadout. A loadout provides item slots for presenting inventory items and/or for providing a marketplace (e.g., presenting advertisements and/or offers for purchasing items) for filling an item slot or for replacing an inventory item presently associated with an item slot.

### COPYRIGHT NOTICE

© 2015 Charles Mimnaugh. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure is directed systems and methods for managing inventory, and more particularly to personal inventory management and marketplace systems and methods.

### SUMMARY

The present disclosure provides inventory management and marketplace systems. The disclosed embodiments provide a visual presentation of a set of inventory items organized using a loadout. A loadout provides item slots for presenting inventory items and can provide a marketplace (e.g., presentation of advertisements or similar offers for purchasing items) for filling an item slot, for replacing an inventory item presently in an item slot, and/or for servicing or repairing an inventory item presently in an item slot.

### BRIEF DESCRIPTION OF THE DRAWINGS

Additional aspects and advantages will be apparent from the following detailed description of preferred embodiments, which proceeds with reference to the accompany drawings, in which:

FIG. 1 is an inventory management and marketplace system 100, according to one embodiment of the present disclosure.

FIG. 2 illustrates an inventory user interface of an inventory management and marketplace system, according to one embodiment.

FIG. 3 illustrates a loadout creator of an inventory management and marketplace system, according to one embodiment.

FIG. 4 illustrates a loadout manager user interface, according to one embodiment.

FIG. 5 illustrates an interactive shopping interface, according to one embodiment.

FIG. 6 illustrates a comparison mode user interface, according to one embodiment.

FIG. 7 illustrates a friends list, according to one embodiment.

FIG. 8 illustrates a flow diagram of a method for managing inventory, according to one embodiment.

FIG. 9 illustrates a flow diagram of a method for gamifying an inventory management system, according to one embodiment.

### DETAILED DESCRIPTION OF PREFERRED EMBODIMENTS

Certain occupations, hobbies, and other activities require particular equipment to perform and/or enjoy. A carpenter, for example, may require numerous tools, such as hammers, saws, lathes, and the like to perform his occupation. A person who enjoys kayaking also may need certain gear or equipment, such as a kayak, a spray skirt, a paddle, a life jacket, and a helmet, in order to kayak, and may desire additional equipment such as a spare paddle, surf shorts, wicking clothing, and a waterproof bag, to more fully enjoy kayaking. Another activity that requires certain equipment is snowboarding. A snowboarder requires a snowboard, bindings, boots, a coat, board pants, and gloves. Obtaining, maintaining, and tracking equipment for various activities can be a significant organizational undertaking.

Shopping lists and inventory management products are tools that help people stay organized. However, these tools present several challenges. Shopping lists are a typical way to ensure that several needed products are purchased during one shopping trip. However, these shopping lists do not track the current inventory of a person, contain little information about each product, and can be disorganized. Similarly, inventory management products can aid in tracking items, but do not provide a way to easily purchase needed items or add recently purchased items. Further, both of these tools also can be increasingly confusing as the number of items being tracked in the tools increased. Therefore, a combination of these two existing tools may increase confusion.

The present disclosure provides inventory management and marketplace systems. The disclosed embodiments provide a visual presentation of a set of inventory items organized using a loadout. A loadout provides item slots for presenting inventory items and/or for providing a marketplace (e.g., presenting advertisements or similar offers for purchasing items) for filling an item slot or for replacing an inventory item presently in an item slot.

In certain embodiments, systems and methods provide management of inventory in a personalized and customizable manner and provide a marketplace through which to acquire additional items to add to the inventory and/or to replace items in the inventory. The figures and descriptions, relate particularly to embodiments wherein the inventory is a personal inventory (e.g., personal belongings such as gear and/or equipment used during various activities of an individual). However, the present invention is not limited to a personal inventory or in any manner by the type of inventory.

Systems and methods which represent embodiments and example applications of the invention will now be described with reference to the drawings. Variations to the systems and methods which represent other embodiments will also be described.

The features of the systems and methods are described with reference to the drawings summarized above. Throughout the drawings, reference numbers are re-used to indicate correspondence between referenced elements. In addition, the first digit of each reference number indicates the figure in which the element first appears. The drawings, associated descriptions, and specific implementation are provided to illustrate embodiments of the invention, and not to limit the scope of the invention. The scope of the invention is defined by the appended claims.

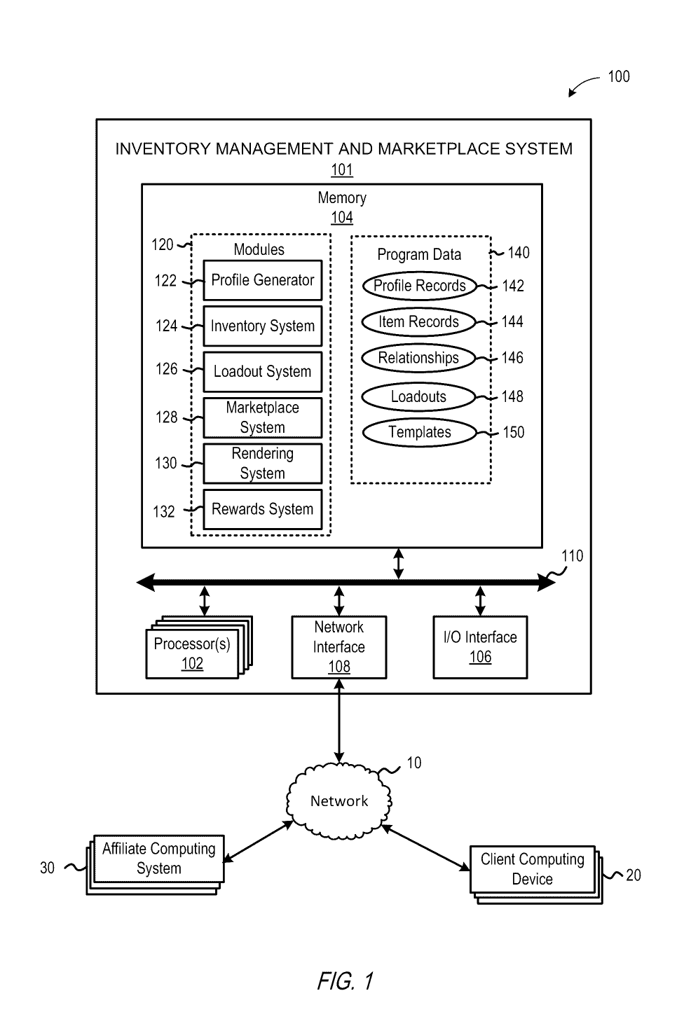

FIG. 1 is an inventory management and marketplace system 100, according to one embodiment of the present disclosure. The system 100 may include a central server computing system 101 (or server), one or more client computing devices 20 (or clients), and one or more affiliate computing systems 30 coupled via a network 10.

The server computing system 101 may include one or more processors 102, a memory 104, an I/O interface 106, and a network interface 108. A bus 110 may interconnect and allow electrical communication between these components.

In one embodiment, the processor unit runs a standard operating system and performs standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The server computing system 101 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The memory 104 may include information and instructions necessary to implement various components of the inventory management and marketplace system 100. For example, the memory may contain modules 120, and program data 140.

As used herein, the word “module”, whether in upper or lower case letters, refers to logic that may be embodied in hardware or in firmware, or to a collection of software instructions, possibly having entry and exit points, written in a programming language, such as, for example, C++. A software module may be compiled and linked into an executable program, included in a dynamic link library, or may be written in an interpretive language such as BASIC. A software module or program may be in an executable state or referred to as an executable. An ‘executable’ generally means that the program is able to operate on the computer system without the involvement of a computer language interpreter. The term ‘automatically’ generally refers to an operation that performs without significant user intervention or with some limited user intervention. The term ‘launching’ generally refers to initiating the operation of a computer module or program. As can be appreciated, software modules may be callable from other modules or from themselves, and/or may be invoked in response to detected events or interrupts. Software instructions may be embedded in firmware, such as an EPROM. Hardware modules may be comprised of connected logic units, such as gates and flip-flops, and/or may be comprised of programmable units, such as programmable gate arrays or processors. The modules described herein are preferably implemented as software modules, but may be represented in hardware or firmware.

The modules 120 may be implemented in hardware, software, firmware, and/or a combination thereof. For example, as shown, modules 120 may include a profile generator 122, an inventory system 124, a loadout system 126, a marketplace system 128, a rendering system 130, and a rewards system 132. Additionally modules 120 may be added and/or combined as desired. These modules 120 may handle various interactions between the server computing system 101, the client computing devices 20, and/or the one or more affiliate computing systems 30. Further, these modules may create data that can be stored by the memory 104. For example, these modules 120 may generate program data 140 such as profile records 142, item records 144, relationships 146, and loadouts 148. The memory 104 may also store other program data such as user data, item data, and/or other user (e.g., affiliate or client) data or information.

The profile generator 122 may be configured to receive information about a user managing an inventory and generate a profile 142 record to be stored by the memory 104. For example, the profile generator 122 may request information from a user of a client computing device 20. The user may manually provide certain parameters via a customer interface (e.g., fillout input components in a form). Alternatively, some embodiments may be configured to interface with and receive information from pre-established profiles of an external social networking system. For example, a web-crawler may obtain and provide information from existing profiles. The profile generator 122 may then generate a profile 142 based off of the information of the external social networking system and may store and/or sync the profile 142, thereby retaining user information. This would allow, for example, the profile generator 122 to access or otherwise interact with user profiles stored in the profile database or user profiles of one or more separate, external social network systems. As can be appreciated, the user may be an individual (a person), or another form, such as business entity or other organization.

The profile generator 122 may also allow a user to connect with other users. For example, a user may find friends or individuals with common interests. The user may link those with a certain interest into a group, which may be referred to as a crew. Each of the group members may be referred to as a crewmember. Linking users in a crew may allow the user to interact with and view inventory of those with similar loadouts to get ideas on which products to buy. In some embodiments, a crew may be a social circle of users that share a type of loadout. A crew member can view other crew members' loadouts, or at least their loadout(s) of the type(s) in common. Additionally, crew members may make recommendations (e.g., products, vendors, activities) to other crew members.

The inventory system 124 may be configured to track items in an inventory of a user. More specifically, the inventory system 124 may receive item data for an item and generate an item record 144 that is stored in association with the inventory by the memory 104. In some embodiments, a user may manually fill out certain parameters via a customer interface configured to collect the item data for generating an item record 144. For example, an individual may desire to enter tools (e.g., carpenter tools), gear (e.g., a kayak, a snowboard) and other equipment into the inventory system 124. The user may also enter, via the customer interface, a year of purchase or manufacture of the item, time owned, condition, manufacturer, and model. The item record may include or otherwise contain an association with product information, such as specifications, images, and other product information that may be generically provided (e.g., by an affiliate or other users) for an item, as described more fully below.

Alternatively or in addition, in some embodiments the inventory system 124 includes an item data collector configured to access data sources over a network via a network interface to identify and collect information pertaining to item records of items in the inventory. The data collector may operate over any network interface such as, a wireless local area network interface (also known as WiFi™), Bluetooth™, ZigBee™, ethernet, USB™, Long Term Evolution (LTE™), near field communication (NFC), and/or any other wireless protocol or channel. For example, a user may have an inventory containing automobile items. The user may enter a stereo system of the automobile into the inventory system 124. The data collector may then use this information and a network to gather more information (e.g., item data) concerning the stereo from external sources. This item data may be stored by an item record 144 by the memory 104 to retain detailed information about the stereo.

In some embodiments the item data for item records 144 may be collected from affiliate computing systems 30. For instance, the inventory system 124 may be configured to access item data from an affiliate network or website and auto-populate at least a portion of the item data of an item record 144. For example, in one embodiment a user may take a picture of an item, the inventory system may identify the item and gather or otherwise access item data such as make, model, reviews, and other relevant information, and generate an item record 144. In other embodiments, item data may be input into the inventory system 124 by scanning the item with a barcode reader, linked from an online purchase, or input via a menu database. Still other embodiments may auto populate item data within an item records 144 when a user types in the product name. Yet another embodiment may suggest possible items based on other item records in the inventory. For example, if the system 100 identifies that the majority of persons owning one item also own a second item, the system may suggest the second item to the user and auto-populate all or a portion of item data of an item record 144.

The loadout system 126 may be configured to receive input specifying a set of inventory item slots to generate a loadout 148 to organize and/or group items in an inventory. Each inventory item slot may specify a type of item to be associated with the inventory item slot. A loadout 148 may be associated with one or more profile 142 records. Further, the loadout system 126 may be configured to receive input designating at least one item record 144 to be associated with at least one inventory item slot of the loadout 148. The item record 144 may represent an item of the type specified by the associated inventory item slot.

In some embodiments, the loadout system 126 may further include a loadout editor that is configured to enable customization of previously created loadouts 148 by receiving input specifying an edit to a loadout 148 and modifying the loadout 148 according to the edit.

In some embodiments, the loadout system 126 may further include a loadout creator may be configured to receive the input specifying the set of inventory item slots from a user managing an inventory and to generate the loadout 148. Further, the loadout creator may be configured to receive input that specifies one or more loadout characteristics and generate the loadout 148 according to the one or more loadout characteristics. For example, loadout characteristics may include graphical elements (image, diagram, etc.) that can provide a backdrop and/or context for the loadout 148 (and/or a graphical representation thereof), item slots included in the loadout 148, an organization (position, size, interrelation) of item slots, and/or other organizational/appearance features.

In some embodiments, the loadout characteristics may include specification of one or more trim levels (or variations). For example, for a ski loadout there may be a warm weather variation and a cold weather variation. The warm weather variation of the ski loadout may include, for example, a lighter ski jacket in a coat item slot and may have fewer active slots than the cold weather loadout variation. The cold weather variation may include additional item slots for items like neck gators or extra layers of clothing. Another example of ski loadout variations may be a powder day variation and a hard pack variation. The powder day variation may include powder skis in a skis item slot, and a multi-purpose pair of skis may be slotted in the skis item slot for the hard pack variation.

In other embodiments, the loadouts may be stackable, such that a loadout may include other loadouts. In this manner, more complex inventories may be organized according to zones, or tiers of detail. For example, a car loadout may be organized according to zones and include a loadout for each zone. A user may interact with, for example, a hood zone that would zoom in or drill down to a more detailed loadout of the components under the hood. This more detailed loadout may include item slots for different engine components, such as air intakes, turbos, batteries, spark plugs, and the like. This more detailed loadout of the hood zone may include local characteristics, such as a different graphical element (specific to under the hood), a set of item slots, and an organization of the item slots.

In yet other embodiments, the loadout creator may be configured to receive the input specifying the set of inventory item slots as a selection of a pre-defined loadout template from a plurality of loadout templates and is configured to generate the loadout 148 based on the template.

The marketplace system 128 may be configured to receive, over the network 10, from an affiliate computing system 30, an offer pertaining to an inventory item slot. The offer may be offer to sell (e.g., to a user) an item of the type specified by the inventory item slot. Alternatively, the offer may be from another user to purchase an inventory item. In some embodiments, a user of a client computing device 20 may make an offer to buy or sell inventory items to other client computing device 20 users.

The rendering system 130 may be configured to render (e.g., to/on a display) a graphical representation of the loadout 148, including the set of inventory item slots and associated item records 144. For example, the inventory item slots may be arranged in a grid. In other embodiments, the rendering system 130 may display a diagram, image, or other graphical element associated with the loadout 148 (e.g., an image of the user during an activity associated with the loadout and corresponding inventory items) and arrange the inventory item slots in association with the graphical element.

The rewards system 132 may be configured to track rewards, such as a rewards currency, provided or otherwise allocated to a user profile record. The reward system 132 may be further configured to generate tasks to be accomplished by the user managing the inventory and provide reward currency to the user profile record upon completion of the task. For example, the rewards system 132 may generate a task for a user to recommend an item to another user (e.g., a crew member). If the other user adds the recommended item, the rewards system 132 may award the recommending user with reward currency.

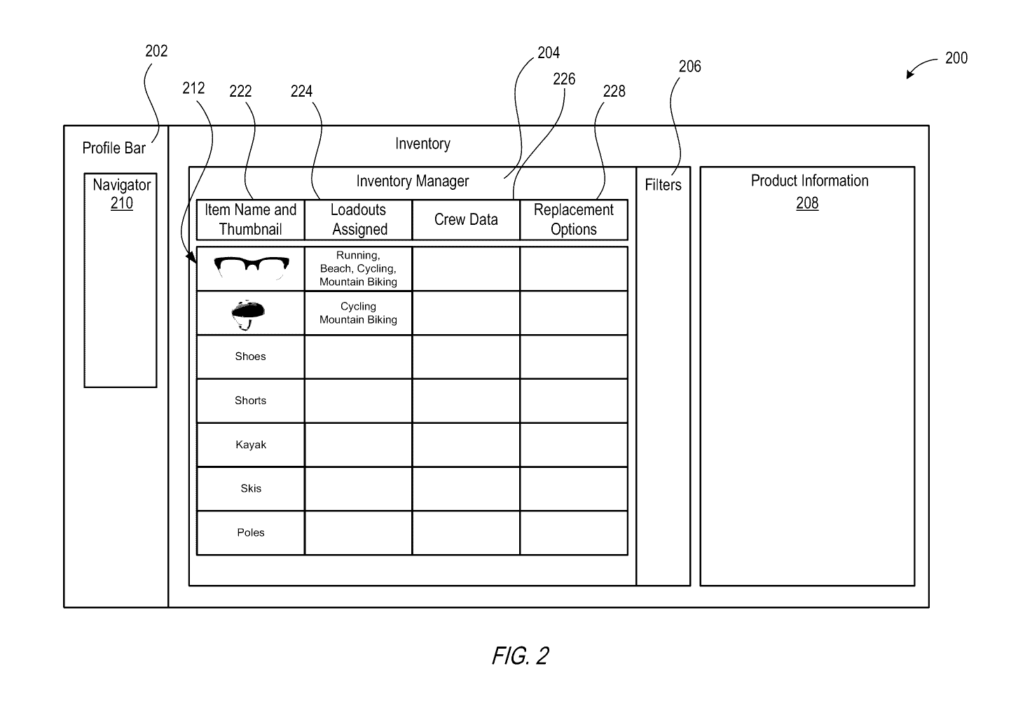

FIG. 2 illustrates an inventory user interface 200 of an inventory management and marketplace system (e.g., the system 100 of FIG. 1), according to one embodiment. The inventory user interface 200 may include a profile bar 202, an inventory manager 204, one or more filters 206, and a product information presenter 208. The inventory user interface 200 may present a visual portrayal of at least a portion of the inventory items of a user. In other words, the inventory user interface 200 may provide a visual portrayal of item records for items of the user's inventory as tracked by the inventory management and marketplace system. The inventory user interface 200 may also allow user interaction for populating, manipulating, managing, and otherwise interacting with the inventory, and the item records data for items in the inventory, in particular.

The profile bar 202 may provide profile information from a profile record of a current user (e.g., a currently logged in user). The profile bar 202 may also provide a navigator 210. The navigator 210 may provide links to various pages of the site, and/or options to sign-out, change account, etc.

The inventory manager 204 may display a representation of a user's real world inventory and associated system information. The inventory manager 204 may be a user interface to the inventory system 124 of FIG. 1 or a tool for interacting with an inventory and/or item records 212 for items in an inventory managed using the inventory system 124. In some embodiments, as shown in FIG. 2, item records 212 (or representations thereof; e.g., a thumbnail image) may be presented in the displayed representation of the user's inventory. The inventory manager 204 may present information concerning the inventory in a spreadsheet, table, or grid, or similar type fashion, with information pertaining to individual items provided and/or grouped in respective rows, with one item per row. Each row may have additional information and status options separated or otherwise arranged into columns. In other words, the columns within a row may provide data fields or information fields for data/information pertaining to an item. For example, the inventory manager 204 may display a graphical representation of an item record 212, which may include an item name and/or image (e.g., a thumbnail image) and/or video of an item in a first column 222, thereby identifying the item represented by an item record 212. A second column 224 may identify loadouts with which the item record 212 is associated. The item record 212 may be associated with one or more loadouts, or no loadouts at all. A third column 226 may display crew data, such as an indication of crews with which the item record 212 is associated, a count of crewmembers that also own the item, and ratings/recommendations of associated crews for the item. A fourth column 228 may display information relating to replacing the item, such as a new item sold by an affiliate, a crewmembers recommendation, a source of original purchase of the item, and/or a length of ownership (or time the item has been in the inventory). Additional columns may be added for additional information

Additionally, the inventory manager 204 may allow the user to add or remove inventory item records 212 and associated system information. For example, the first column 222 may allow the user to add or remove an item record 212. In one embodiment, item records 212 may be automatically added if an item is purchased through the system from a system administrator (e.g., a quartermaster), or from an affiliate. In another embodiment, custom items or out of affiliate network items may also be added. In certain instances, the user may select images/pictures and names of the items that are included in a corresponding item record 212. In yet another embodiment, a user can use a smart phone or barcode scanner to scan barcodes on purchase items and have the column or information fields of an item record 212 automatically populated. The second column 224 may enable the user to assign an item record 212 to a loadout. The item record 212 may be associated with a single loadout or with a plurality of loadouts. For example, the sunglasses item record 212 has been associated with a running loadout, a beach loadout, a cycling loadout, and a mountain biking loadout. The third column 226 may display crew data for crews with which the item record 212 is associated (and/or with which the loadouts are associated) and may enable the user to rate the item to share his impressions (e.g., ratings, recommendations) of the item with the crew(s). The fourth column 218 may allow a user a user to mark the item record 212 for an action, such as for replacement, service or repair. Timer, data tracking, or other functionality may be provided for automatically marking item records 212, such as for replacement (e.g., upon expiration of an item, such as a car seat, a helmet) or for service (e.g., 3 months for an oil change). The user may also mark the item record 212 to not receive offers related to that item.

The filters 206 may allow the user to filter and sort the presentation of item records 212 in the inventory manager 204. Various filters 206 may be provided for filtering and sorting the listing of item records 212 by the inventory manager 204. For example, filters 206 may be provided for filtering and/or sorting the item records 212 according to loadout associations, or according to crew associations. As another example, filters 206 may be provided for filtering and/or sorting item records 212 according to expiration date, marking for replacement, time in inventory, and the like.

The product information presenter 208 may present information gathered by the inventory administrator (e.g. owner) or by the system administrator. For instance, the inventory administrator may search the Internet for information pertaining to an item. This information may include data particular to the item (e.g., reviews, photos, videos, etc.), or data about a related product that a user may be considering replacing the item with. The resulting information may be added, linked to, or otherwise included in the product information presenter 208. For example, the inventory administrator may search for information on affiliates' databases, social networks, online forums, the user's or crewmembers' inventory, product reviews, video services, and other sources. By searching these sources, product information such as videos, photos, reviews, and other information from the internet may be added to the product information presenter 208.

In other embodiments, the product information presenter 208 may present information automatically gathered by the inventory management system and marketplace system. For example, the system may accumulate information about a product through automatic searches for information on affiliates' databases, social networks, online forums, the user's or crewmembers' inventory, product reviews, video services, and other sources. By searching these sources, item information such as videos, photos, reviews, and other information from the internet or other accessible data source may be added to the product information presenter 208 automatically.

In some embodiments, system administrator (e.g., quartermaster) user base statistics may be displayed in the product information presenter 208. These statistics may include, the number of other users that own an item, the system administrator ratings, overall owner ratings, and/or system administrator user media. The system administrator user media may include stock pictures and videos for an item.

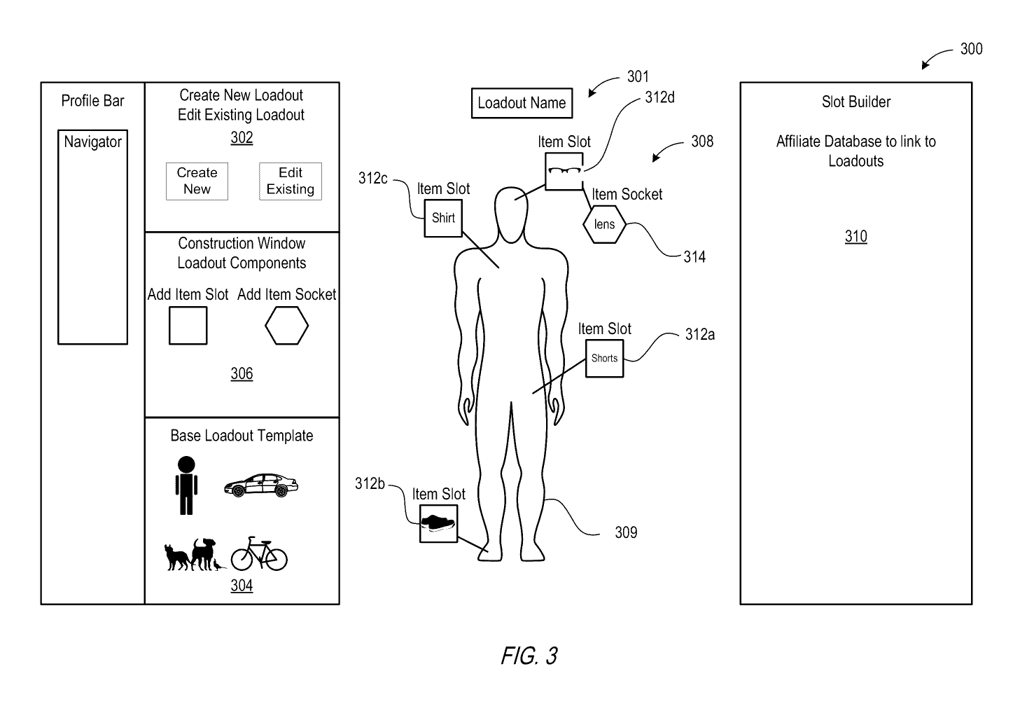

FIG. 3 illustrates a loadout creator 300 of an inventory management and marketplace system, according to one embodiment. The loadout creator 300 may be an interface to or tool for interfacing with the loadout system 126 of FIG. 1. The loadout creator 300 may be configured to receive input specifying a set of inventory item slots 312a, 312b, 312c, 312d, etc. (collectively 312) from the user managing the inventory and to generate a loadout 301. The loadout creator 300 may include a loadout loader 302, a loadout template manager 304, a component toolbar 306, a graphical representation 308 of the loadout 301, and a slot builder 310.

The loadout loader 302 may enable a user to create a new loadout 301 or edit an existing loadout 301. The loadout loader 302 may provide input components or options for creating a new loadout or for loading and editing an existing loadout.

The loadout template manager 304 may display several base loadout templates that are selectable by a user. When a user selects one of these templates, the loadout creator 302 may present a graphical representation 308 of or for the loadout 301 that is based on the selected template as well as a typical arrangement of item slots 312 and item sockets 314. For example, base templates may include a human, car, pet, bicycle, or a custom/hybrid template created by the user. If a user were to select the human template, a graphical element 309 that is a human cutout, such as shown in FIG. 3, may be presented in the graphical representation 308. The human template may be useful for creating a loadout 301 for inventory items pertaining to gear used on or worn by a human. For example, the human template may be used for creating a runner loadout that includes items in the inventory related to running. In such an embodiment, the item slots 312 and item sockets 314 may be preloaded and located near areas of the graphical representation 308 where equipment may be typically used and needed by a runner. An item slot 312a for shorts may be presented near a leg, an item slot 312b for shoes may be presented near the feet, an item slot 312c for a shirt may be presented by the torso, and an item slot 312d for glasses may be presented near the head. The item slot 312d may include an associated item socket 314, which may provide for one or more components or parts of an item associated with the item slot 312d (e.g., one or more different lenses for the glasses). Other item slots 312 may have other item sockets for components or parts (e.g., other items) for or associated with items in the inventory.

The component toolbar 306 may enable a user to add additional item slots 312 and item sockets 314. If the user started from a base loadout template and added additional item slots 312 or item sockets 314, the new configuration may be saved back to the template or the user may save the configuration as a new loadout. In some embodiments, the user may select which component to add and then select an area or position to add it to on the graphical representation 308. Other embodiments may use a drag and drop placement approach.

The graphical representation 308 may display a graphical element 309 and associated item slots 312 and item sockets 314. The graphical element 309 may be a background of and/or provide visual context for a loadout 301 as displayed by the graphical representation 308. The graphical element 309 may be an image selected from a gallery, preloaded as part of the base template, or uploaded by the user. The graphical element 309 may provide a backdrop that gives context for the loadout 301. In other words, the graphical representation 308 may present a visual representation of a loadout 30 that may provide a visual cue as to where and/or how an item of the inventory is typically used.

An item slot 312 may be a virtual container within a loadout. An item slot 312 may designate a type of item and may be represented in the graphical representation 308. An item slot 312 may designate a type of specific item for an area of ownership of inventory. For example, the item slot 312a may designate an item type that is “shorts” or more specifically “running shorts.” As another example, the item slot 312b may designate an item type that is “footgear” or “shoes” or more specifically “running shoes.” Within the graphical representation 308, an image of an item may be displayed within the representation of an item slot 312. The image may be a graphical representation of an item (and more specifically an item record) occupying an item slot 312. The image may be linked to or included within an item record of the occupying or otherwise corresponding item record. In other embodiments, the image of the item may be representative of a designated item type, for example, to indicate the type of item (e.g., item record) to be associated with a presently empty item slot 312. The image may be uploaded by the user or may be automatically loaded from the a system administrators' database, an affiliates' database, or other image source or database. As can be appreciated, the item slots 312 may be placed in various positions and represented as various sized shapes within the graphical representation 308 and/or relative to the graphical element 309.

Certain item records in an inventory may include or otherwise be broken down to individual components. Accordingly, the item slots 312 can be separated into or be associated with one or more item sockets 314. Item sockets 314 are virtual containers for items (e.g., item records) that are reliant on or a subcomponent or smaller part of an item. Item sockets 314 are virtual containers for subcomponents of items in item slots 312. For example if the item slot 312d was for glasses, item socket 314 could be for lenses (e.g., tinted lenses to replace a standard clear lenses).

The slot builder 310 may enable a user to set or designate inventory items (and more particularly item records) as belonging in a given item slot 312 and item socket 314. In other word, the slot builder 310 may allow sorting and/or categorizing inventory item records within a loadout 301. In certain embodiments, a user may be presented with a direct link, for example from an affiliate database, for an item record of an item that the user may have in an inventory and that may fit within an item slot 312. For example, if a user purchases an item from an affiliate database, the item record and a direct link to a presentation of the item on the affiliate database may be automatically presented to enable adding an item record for the newly purchased item to an item slot 312. In other embodiments, if an item slot 312 is left empty, a suggested item available from an affiliate database may be presented for the user to purchase. The slot builder 310 may set filters to select or otherwise identify items available through the affiliate database that may be of interest and/or pertinent to a given item slot 312. For example, if a user had not yet designated an item (e.g., an item record for an item) from inventory for item slot 312a, the user may be presented with item records for potential items from inventory for adding to the item slot 312a and/or item records or other presentation of items available for purchase through one or more affiliate websites. The user may apply a filter to the item slot 312a to just show certain item records associated with that item slot 312 from that affiliate. In certain embodiments, a position or location of an item slot 312 within the graphical representation 308 may also provide a filter within the slot builder 310 in some embodiments. For example, if an item slot 312 is positioned near the feet of a human graphical element 308 within a graphical representation 308, the slot builder 310 may only show footwear.

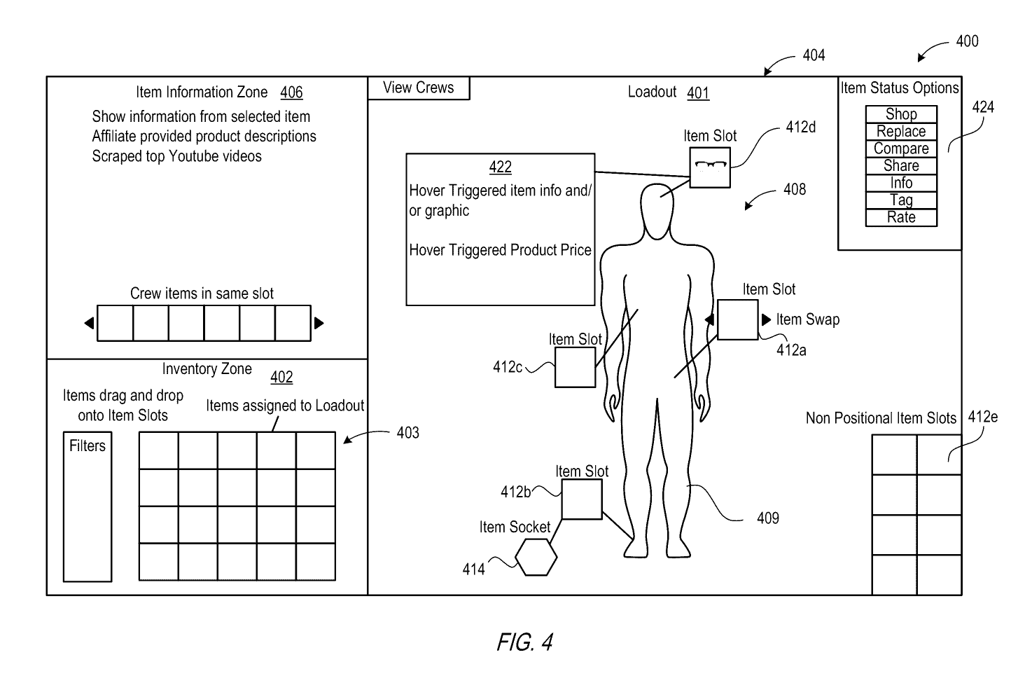

FIG. 4 illustrates a loadout manager user interface 400, according to one embodiment. The loadout manager user interface 400 may present the item records of items a user owns and has linked to a loadout. More particularly, the loadout manager user interface 400 may present a graphical view 408 or graphical representation of a loadout 401. The loadout manager user interface 400 may also enable a user to add/remove item records associated with a loadout 401. The loadout manager interface 400 may include an inventory zone 402, an item information zone 406, and a loadout presenter 404.

The inventory zone 402 may display representations of item records currently assigned to the loadout. Certain embodiments may present the item records assigned to the loadout in a spreadsheet 403 or grid, as shown. Other embodiments may present a listing or other representation of item records of the loadout. In another embodiment one or more filters may be available to limit the item records presented to a certain type. These item records may be assigned to specific item slots 412 that are shown or otherwise presented by the loadout presenter 404. For example, a user may drag and drop the item record into an item slot 412. Alternatively, in some embodiments a user may select the item record then select the item slot 412.

The loadout presenter 404 may provide a graphical view 408 of a loadout 401, which may include a graphical element 409, item slots 412a, 412b, 412c, 412d, 412e (collectively 412), and item records currently assigned to the item slots 412 of the loadout 401. For example, in some embodiments item slots 412 may contain item records of items generally associated with various parts of the human anatomy. An item record of the item that correlates to a certain area may be contained in an item slot 412 positioned over or around that area of a human cutout graphical element 409, as shown in FIG. 4. There may also be non-positional item slots 412e that may relate to the loadout 401, but may not correspond to an area of a graphical element 409 of a loadout.

The loadout presenter 404 may also provide a way to interact with the item records contained in the item slots 412. In some embodiments, a user may hover a curser over an item slot 412 to trigger additional information 422 about that item. The additional information may include pricing, ratings, and other pertinent information. In some embodiments, if an item slot 412 is selected, the user may also be able to interact with the item record's status using item status options components 424. For example, the item status options 424 may enable a user to shop, replace compare, share, get info, tag, or rate the item.

The item information presenter 406 may provide information on an item of a selected item record. In some embodiments, the information may include information from affiliate databases. The information may also include internet videos associated with the item and/or item record. In yet another embodiment, the item information presenter 406 may display what crew members (e.g., item records of items from crew member inventories) have associated in a selected item slot 412. This may provide a user with suggestions for what to replace or add to his own inventory.

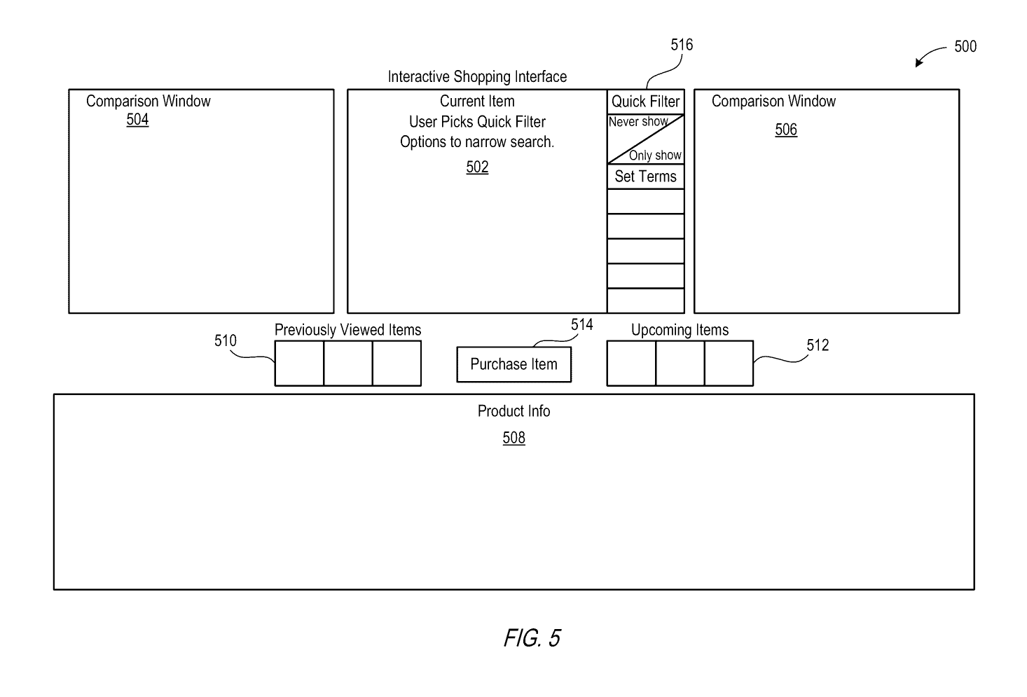

FIG. 5 illustrates an interactive shopping interface 500, according to one embodiment. In some embodiments, this interface 500 may be accessed when the user clicks an item record or item slot to shop for it. In some embodiments the interactive shopping interface 500 may comprise a current item window 502, multiple comparison windows 504 and 506, a product info area 508, and a queue (i.e., previously viewed items 510, and upcoming items 512).

The current item window 502 may present a product for sale from an affiliate, other user, system administrator, or other source. The user may use filter options 516 to limit the search for potential items as they are brought through the queue (i.e., previously viewed items 510, and upcoming items 512). Information on the product may appear in the product info area 508.

The queue may display previous items as well as upcoming items. A user may easily navigate back or skip several upcoming items by selecting one of the items in the queue. The queue may be promoted items from affiliates or it may be items that other users and/or a user's crew has highly rated.

The comparison windows (504 and 506) may retain an item to compare to other items displayed in the current item window 502. For example, if a user likes an item in the queue but wishes to see more items, the user can select the item and move it to the comparison window 504. This would allow a user to compare multiple items.

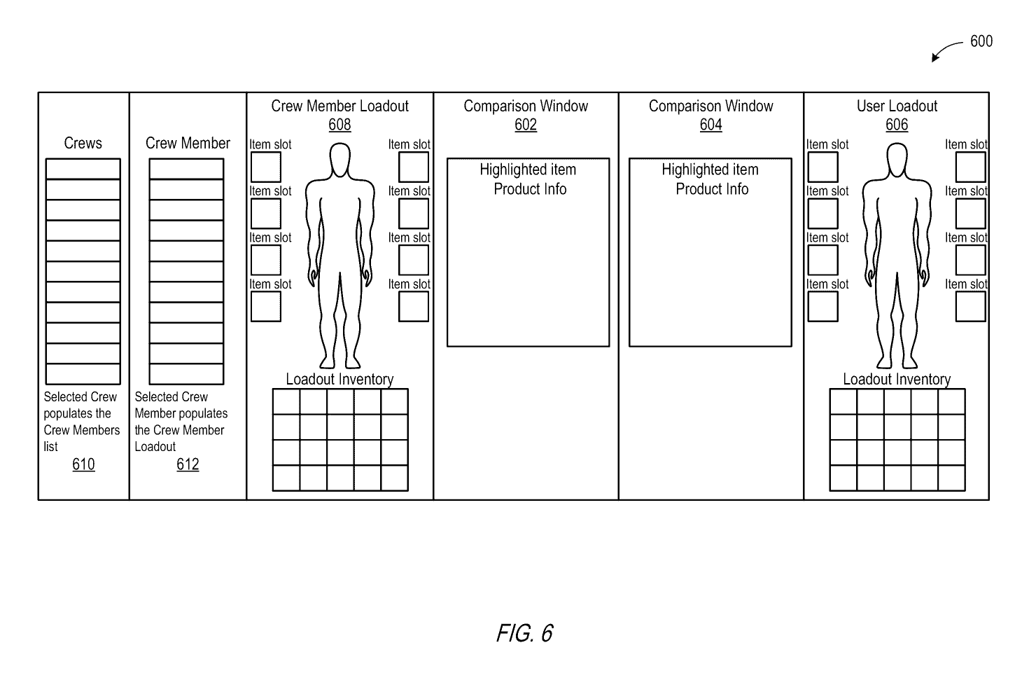

FIG. 6 illustrates a compare mode user interface 600, according to one embodiment. The compare mode user interface 600 may present a comparison of items in a user's inventory to items of a second inventory managed by a second user based on a second user profile. The second user may be a crewmember of the first user. The compare mode page 600 may comprise two or more comparison windows 602 and 604, a user loadout area 606, a crew member loadout area 608, a crew selection area 610, and a crew member selection area 612.

A user may select a crew that he wishes to compare his loadout to from the crew selection area 610. The crew member selection area 612 may then present the members of a selected crew. The user may select one or more of the crew members for comparison of loadouts.

The crew member loadout area 608 and user loadout area 606 may display a selected crew member's loadout and the users loadout respectively. This provides an overview of the items in each inventory. The user may select one or more of the items to compare in more detail in the comparison windows 602 and 604.

The comparison windows 602 and 604 may display detailed item information from a user's loadout and a crew member's loadout. For example, the windows could display seller, brand, model price, rating, crew recommendation, size, and/or color.

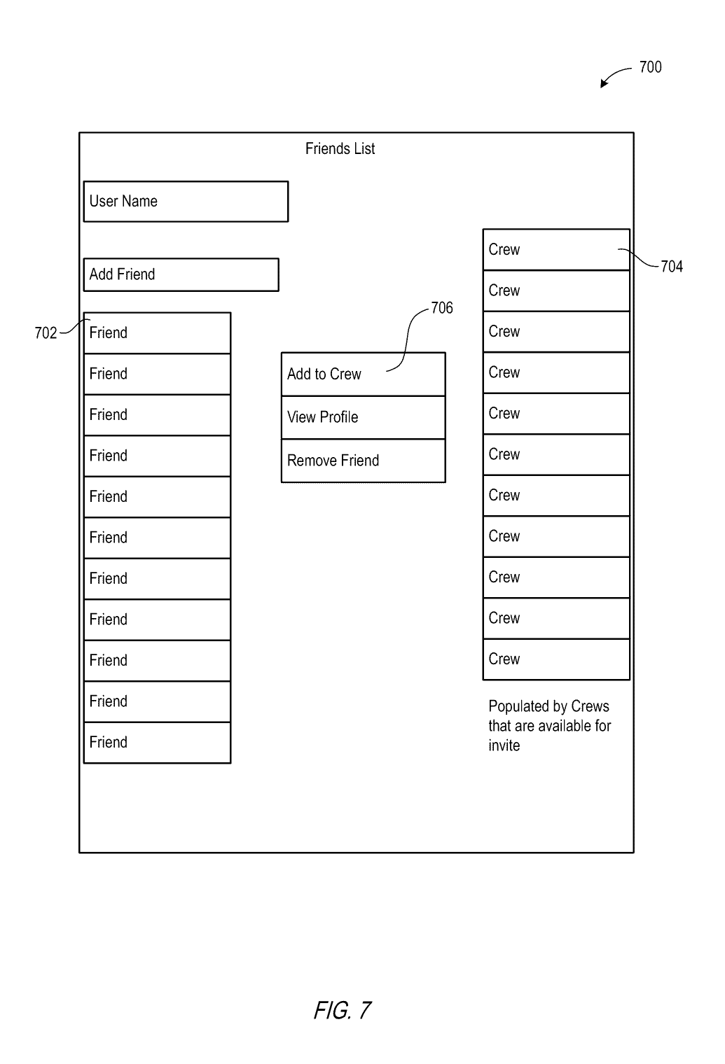

FIG. 7 illustrates a friends list 700, according to one embodiment. In some embodiments, this may provide a way to add/remove friends, and arrange friends into crews. The friends list 700 may include a friend list area 702, a crew list area 704, and an action area 706.

The friend list area 702 may display a user's friends. In some embodiments, the list may include suggested friends based on common interests, crew, loadouts, and/or friends.

The crew list area 704 may display a user's crews. In some embodiments the user may be able to create new crews from this page. In other embodiments, the crews are automatically generated based on the loadouts of a user's profile.

The action area 706 may enable a user to interact with a selected friend or crew. For example, as shown in some embodiments, if a user selects a friend, options to add that friend to a crew, view the friend's profile, and remove the friend appear. If the user selects add to crew, the friend may then be associated with that crew. Friends may be associated with multiple crews. Crews may be determined based on shared loadouts. In some embodiments, friends can be automatically assigned to a crew based on which loadouts the users have in common. By grouping persons with similar interests, it may allow for better purchase recommendations. Further, in alternate embodiments, there may be a crew purchase option. For instance, if multiple members of a crew purchase an item they may be eligible for a group discount.

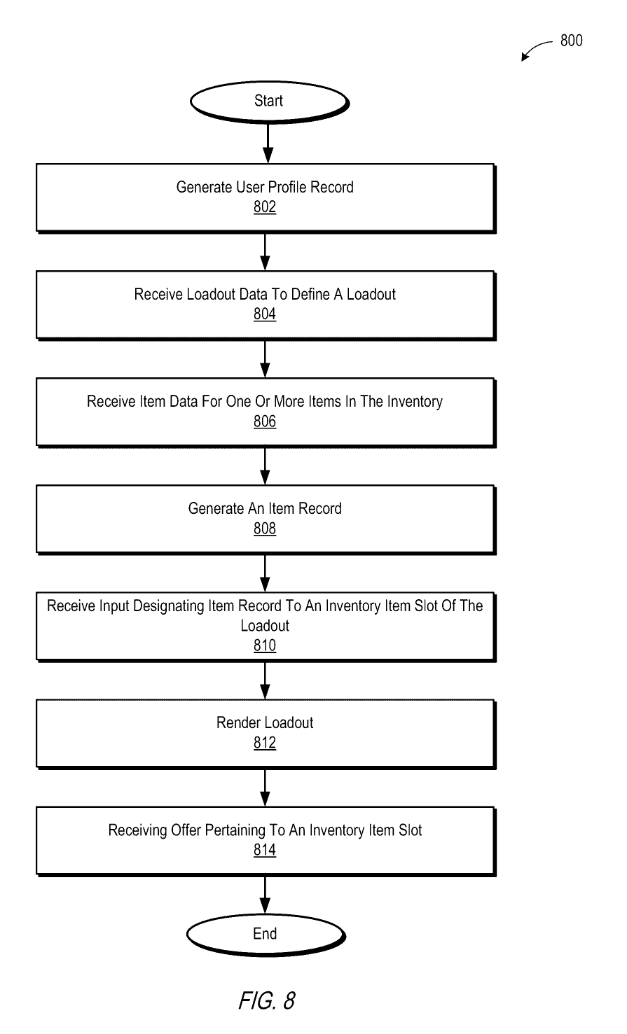

FIG. 8 illustrates a flow diagram 800 of a method for managing inventory, according to one embodiment. A user profile may be generated 802 on a computing device. The user profile may include information for a user managing an inventory. The computing device may receive 804 loadout data to define a loadout. The loadout may include a plurality of inventory item slots to organize/group a set of items in the inventory. The inventory item slots may specify a type of item to be associated with the inventory item slot. The computing device may also receive 806 item data for one or more items in the inventory.

An item record may be generated 808 using received item data. Input designating at least one item record to be associated with at least one inventory item slot of the loadout may be received 810. A graphical representation of the loadout, including the plurality of inventory item slots and associated item records may be rendered on a display.

The method may further receive 814 an offer pertaining to an inventory slot. For example, a user may decide to replace a shoe designated for a foot item slot. An affiliate may be able to send an offer to the user for a shoe.

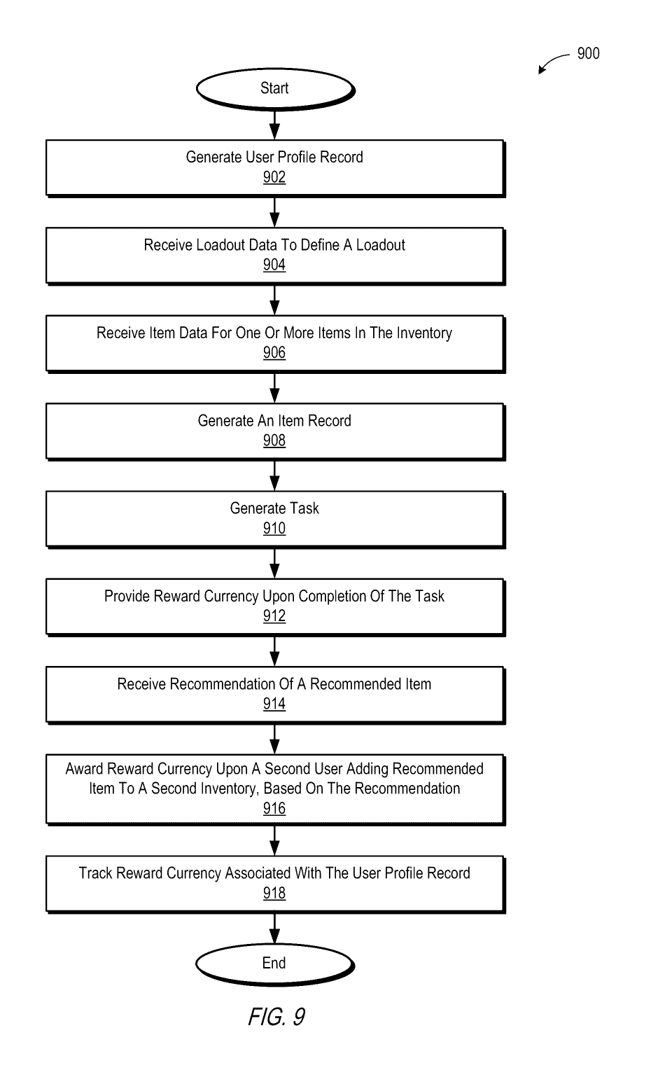

FIG. 9 illustrates a flow diagram 900 of a method for gamifying an inventory management system, according to one embodiment. A user profile record may be generated 902. Loadout data may be received 904. This loadout data may be used to define a loadout. A loadout may be a way to organize items in a user's inventory. Item data may be received 906 for one or more items in a user's inventory. An item record may be generated 908 based on the item data.

A task may be generated 910. These tasks gamify the system to encourage player involvement in the inventory management system. These tasks may be repetitive daily quests, and/or progression quests. The daily quests may encourage a user to create new loadouts, connect more socially, and edit inventory. For example, daily quests may include challenges to create a new loadout, update an existing loadout, add new item, suggest item to crew, buy new item, upvote/downvote Items, write a review, upvote/downvote other user's reviews, geoTag an item, upload video for item, add new crew member to crew, join public crew, and/or have a crew member buys an item from an equipped loadout. Progression quests may encourage profile progression. For example a progression task may include challenges to do a certain thing several times such as create a certain number of Loadouts, link a certain number Items, buy a certain number of items, etc. Progression quests may also deal with creating a user profile, creating a first loadout, and other initial tasks.

Upon completion of one of a task, reward currency may be provided 912. For example, upon completing a task a user may be given reward points. In alternate embodiments bonus features such as theme packs may be rewarded. In yet other embodiments users may also qualify for cash payouts. Rewards may also be given for successful recommendations of a product.

A recommendation of an item may be received 914. Reward currency may be awarded 916 upon a second user adding recommend item to a second inventory based on the recommendation. Reward currency associated with a user profile record may be tracked 918.

### EXAMPLES

### Example 1

A personal inventory management and marketplace system, comprising: one or more processors; a memory in electrical communication with the one or more processors to store profile records, item records, and loadouts; a network interface configured to communicate over a communication network with one or more client computing devices; a profile generator configured to receive information about a user managing an inventory and generate a profile record to be stored by the memory; an inventory system configured to track item records for items in the inventory, the inventory system configured to receive item data for an item and generate an item record that is stored by the memory; a loadout system configured to receive input specifying a set of inventory item slots to generate a loadout to organize/group items in the inventory, each inventory item slot specifying a type of item to be associated with the inventory item slot, the loadout associated with the profile record, wherein the loadout system is further configured to receive input designating at least one item record to be associated with at least one inventory item slot of the loadout, the item record representing an item of the type specified by the inventory item slot; a rendering system configured to render, to a display, a graphical representation of the loadout, including the set of inventory item slots and associated item records.

### Example 2

The system of examples 1, wherein the inventory system includes an item data collector configured to access data sources over a network via the network interface to identify and collect information pertaining to item records of items in the inventory.

### Example 3

The system of any of examples 1 and 2, further comprising a marketplace system configured to receive, over a network, from an affiliate network, an offer pertaining to a first inventory item slot, the offer being an offer to sell an item of the type specified by the first inventory item slot.

### Example 4

The system of example 3, wherein the rendering system is further configured to render the graphical representation of the loadout, including a graphical representation of the offer associated with the first inventory item slot.

### Example 5

The system of any of examples 1-4, wherein the loadout system comprises a loadout editor that is configured to enable customization of previously created loadouts by receiving input specifying an edit to a loadout and modifying the loadout according to the edit.

### Example 6

The system of any of examples 1-5, wherein the loadout system comprises a loadout creator that is configured to receive the input specifying the set of inventory item slots from the user managing the inventory and to generate the loadout.

### Example 7

The system of example 6, wherein the loadout creator is further configured to receive input that specifies one or more loadout characteristics and to generate the loadout according to the one or more loadout characteristics.

### Example 8

The system of example 7, wherein the loadout characteristics include one or more of: a graphical element (image, diagram, etc.) that can provide a backdrop and/or context for the load-out; item slots included in the loadout; an organization (position, size, interrelation) of item slots; trim levels (or variations); and tiers of loadouts.

### Example 9

The system of example 6, wherein the loadout creator is configured to receive the input specifying the set of inventory item slots as a selection of a pre-defined loadout template from a plurality of loadout templates and is configured to generate the loadout based on the template.

### Example 10

The system of any of examples 1-9, wherein the loadout system is configured to operate in a purchase mode, a compare mode, and a manage mode, wherein the purchase mode includes an offer from an affiliate to sell an item to be purchased to be included in the inventory, the offer associated with an item slot of the loadout, the item for sale corresponding to an item type specified by the associated item slot, wherein the compare mode provides a comparison of items in the inventory to items of a second inventory managed by a second user based on a second user profile with which the user profile record has a contact relationship and with which the loadout is also associated, wherein the manage mode allows the user managing the inventory to provide input to associate an item record for an item in the inventory with a given item inventory slot.

### Example 11

The system of any of examples 1-10, wherein the inventory system is configured to access item data from an affiliate network and auto-populate at least a portion of the item data of an item record.

### Example 12

The system of any of examples 1-11, further comprising: a rewards system configured to track reward currency provided to the user profile record, the reward system configured to generate tasks to be accomplished by the user managing the inventory and provide reward currency to the user profile record upon completion of the task.

### Example 13

The system of example 12, wherein the rewards system is configured to receive input indicating a recommendation of a recommended item and award reward currency to the user profile record upon a second user managing a second inventory adding the recommended item to the second inventory, based on the recommendation.

### Example 14

The system of example 12, wherein the rewards system is configured to: receive input from a second user indicating recognition to the user profile record and associated loadout for a prompting purchase of an item by the second user; and award reward currency to the user profile record upon receipt of the input, based on the recognition.

### Example 15

A computer-implemented method for managing inventory, comprising: generating, on a computing device, a user profile record that includes information for a user managing an inventory; receiving, at the computing device, loadout data to define a loadout that includes a plurality of inventory item slots to organize/group a set of items in the inventory, each inventory item slot of the plurality of inventory item slots specifying a type of item to be associated with the inventory item slot, the loadout associated with the user profile; receiving, at the computing device, item data for one or more items in the inventory; generating, on the computing device, an item record that is stored in a memory of the computing device, the item record generated using received item data; receiving, at the computing device, input designating at least one item record to be associated with at least one inventory item slot of the loadout, the item record representing an item of the type specified by the inventory item slot; and rendering, on a display, a graphical representation of the loadout, including the plurality of inventory item slots and associated item records.

### Example 16

The method of example 15, further comprising: receiving, over a network to which the computing device is coupled, an offer pertaining to an inventory item slot, the offer being an offer to sell an item of the type specified by the inventory item slot; and presenting the offer to the user managing the inventory.

### Example 17

The method of any of examples 15-16, further comprising: generating a task to be accomplished by the user managing the inventory; providing reward currency to the user profile record upon completion of the task; tracking reward currency associated with the user profile record.

### Example 18

The method of example 17, further comprising: receiving input from the user managing the inventory providing a recommendation of a recommended item; and awarding reward currency to the user profile record upon a second user managing a second inventory adding the recommended item to the second inventory, based on the recommendation.

### Example 19

The method of any of examples 15-18, wherein receiving item data includes accessing data sources over a network, via a network interface, to identify and collect item data pertaining to an item in the inventory.

### Example 20

The method of any of examples 15-19, further comprising: receiving input indicating or requesting a contact relationship between the user profile record and second user profile record, based on the loadout, such that the user profile record and the second user profile record are each associated with the loadout.

### Example 21

The method of example 20, wherein rendering the graphical representation of the loadout comprises rendering the loadout in a comparison mode such that the graphical representation of the loadout includes inventory item slots, associated item records for items in the inventory, and at least one item record for an item in a second inventory of second user profile record with which the user profile record has a contact relationship.

### Example 22

The method of any of examples 15-21, wherein rendering the graphical representation of the loadout comprises rendering the loadout in a purchase mode such that the graphical representation of the loadout includes inventory item slots, associated item records for items in the inventory, and offers to sell items to fill empty item slots and to replace items in the inventory.

### Example 23

The method of any of examples 15-22, wherein rendering the graphical representation of the loadout comprises rendering the loadout in a comparison mode that includes inventory item slots, associated item records for items in the inventory, and item records for items in a second inventory managed by a second user profile record with which the user profile record has a contact relationship, wherein the loadout is associated with both the user profile record and the second user profile record.

### Example 24

The method of any of examples 15-23, further comprising: receiving input indicating a first item slot of the loadout for replacement; communicating a replacement need to an affiliate seller.

### Example 25

The method of example 24, wherein rendering the graphical representation of the loadout, including the plurality of inventory item slots and associated item records, includes: presenting an indication that the first item slot of the loadout is marked for replacement; and presenting offers to sell a replacement item of the type specified by the first item slot.

The foregoing specification has been described with reference to various embodiments, including the best mode. However, those skilled in the art appreciate that various modifications and changes can be made without departing from the scope of the present disclosure and the underlying principles of the invention. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection.

Principles of the present disclosure may be reflected in a computer program product on a tangible computer-readable storage medium having computer-readable program code means embodied in the storage medium. Any suitable computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture including instruction means which implement the function specified. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified.

Principles of the present disclosure may be reflected in a computer program implemented as one or more software modules. As used herein, a software module or component (e.g., an engine) may include any type of computer instruction or computer-executable code located within a memory device and/or computer-readable storage medium. A software module may, for instance, comprise one or more physical or logical blocks of computer instructions, which may be organized as a routine, a program, an object, a component, a data structure, etc., that perform one or more tasks or implement particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools.

Embodiments as disclosed herein may be computer-implemented in whole or in part on a digital computer. The digital computer includes a processor performing the required computations. The computer further includes a memory in electronic communication with the processor to store a computer operating system. The computer operating systems may include, but are not limited to, MS-DOS, Windows, Linux, Unix, AIX, CLIX, QNX, OS/2, and Apple. Alternatively, it is expected that future embodiments will be adapted to execute on other future operating systems.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

While the principles of this disclosure have been shown in various embodiments, many modifications of structure, arrangements, proportions, the elements, materials and components, used in practice, which are particularly adapted for a specific environment and operating requirements, may be used without departing from the principles and scope of this disclosure. These and other changes or modifications are intended to be included within the scope of the present disclosure.

The scope of the present invention should, therefore, be determined only by the following claims.

What is claimed is:

1. An inventory management system, comprising:
one or more processors;
a memory in electrical communication with the one or more processors to store profile records, item records, and loadouts;
a profile generator configured to receive information about a user managing an inventory and generate a profile record to be stored by the memory;
an inventory system configured to track item records for items in the inventory, the inventory system configured to receive item data for an item and generate an item record that is stored by the memory;
a loadout system configured to receive input specifying a set of inventory item slots to generate a loadout to organize/group items in the inventory, each inventory item slot specifying a type of item to be associated with the inventory item slot, the loadout associated with the profile record, wherein the loadout system is further configured to receive input designating at least one item record to be associated with at least one inventory item slot of the loadout, the item record representing an item of the type specified by the inventory item slot;
a rendering system configured to render, to a display, a graphical representation of the loadout, including the set of inventory item slots and associated item records.

2. The system of claim 1, wherein the inventory system includes an item data collector configured to access data sources over a network to identify and collect information pertaining to item records of items in the inventory.

3. The system of claim 1, further comprising a marketplace system configured to receive, over a network, from an affiliate network, an offer pertaining to a first inventory item slot, the offer being an offer to sell an item of the type specified by the first inventory item slot.

4. The system of claim 3, wherein the rendering system is further configured to render the graphical representation of the loadout, including a graphical representation of the offer associated with the first inventory item slot.

5. The system of claim 1, wherein the loadout system comprises a loadout editor that is configured to enable customization of previously created loadouts by receiving input specifying an edit to a loadout and modifying the loadout according to the edit.

6. The system of claim 1, wherein the loadout system comprises a loadout creator that is configured to receive the input specifying the set of inventory item slots from the user managing the inventory and to generate the loadout.

7. The system of claim 1, wherein the loadout system is configured to operate in a purchase mode, a compare mode, and a manage mode,
wherein the purchase mode includes an offer from an affiliate to sell an item to be purchased to be included in the inventory, the offer associated with an item slot of the loadout, the item for sale corresponding to an item type specified by the associated item slot,
wherein the compare mode provides a comparison of items in the inventory to items of a second inventory managed by a second user based on a second user profile with which the user profile record has a contact relationship and with which the loadout is also associated,
wherein the manage mode allows the user managing the inventory to provide input to associate an item record for an item in the inventory with a given item inventory slot.

8. The system of claim 1, wherein the inventory system is configured to access item data from an affiliate network and auto-populate at least a portion of the item data of an item record.

9. The system of claim 1, further comprising:
a rewards system configured to track reward currency provided to the user profile record, the reward system configured to generate tasks to be accomplished by the user managing the inventory and provide reward currency to the user profile record upon completion of the task.

10. The system of claim 9, wherein the rewards system is configured to receive input indicating a recommendation of a recommended item and award reward currency to the user profile record upon a second user managing a second inventory adding the recommended item to the second inventory, based on the recommendation.

11. A computer-implemented method for managing inventory, comprising:
generating, on a computing device, a user profile record that includes information for a user managing an inventory;
receiving, at the computing device, loadout data to define a loadout that includes a plurality of inventory item slots to organize/group a set of items in the inventory, each inventory item slot of the plurality of inventory item slots specifying a type of item to be associated with the inventory item slot, the loadout associated with the user profile;
receiving, at the computing device, item data for one or more items in the inventory;
generating, on the computing device, an item record that is stored in a memory of the computing device, the item record generated using received item data;
receiving, at the computing device, input designating at least one item record to be associated with at least one inventory item slot of the loadout, the item record representing an item of the type specified by the inventory item slot; and
rendering, on a display, a graphical representation of the loadout, including the plurality of inventory item slots and associated item records.

12. The method of claim 11, further comprising:
receiving, over a network to which the computing device is coupled, an offer pertaining to an inventory item slot, the offer being an offer to sell an item of the type specified by the inventory item slot; and
presenting the offer to the user managing the inventory.

13. The method of claim 11, further comprising:
generating a task to be accomplished by the user managing the inventory;
providing reward currency to the user profile record upon completion of the task;
tracking reward currency associated with the user profile record.

14. The method of claim 13, further comprising:
receiving input from the user managing the inventory providing a recommendation of a recommended item; and
awarding reward currency to the user profile record upon a second user managing a second inventory adding the recommended item to the second inventory, based on the recommendation.

15. The method of claim 11, further comprising:
receiving input indicating a contact relationship between the user profile record and second user profile record, based on the loadout, such that the user profile record and the second user profile record are each associated with the loadout.

16. The method of claim 15, wherein rendering the graphical representation of the loadout comprises rendering the loadout in a comparison mode such that the graphical representation of the loadout includes inventory item slots, associated item records for items in the inventory, and at least one item record for an item in a second inventory of second user profile record with which the user profile record has a contact relationship.

17. The method of claim 11, further comprising:
receiving input indicating a first item slot of the loadout for replacement;
communicating a replacement need to an affiliate seller.

18. The method of claim 17, wherein rendering the graphical representation of the loadout, including the plurality of inventory item slots and associated item records, includes:
presenting an indication that the first item slot of the loadout is marked for replacement; and
presenting offers to sell a replacement item of the type specified by the first item slot.

19. A computer-readable storage medium having stored thereon instructions that, when implemented by a computing device, cause the computing device to perform operations for managing inventory, the operations comprising:
generating, on a computing device, a user profile record that includes information for a user managing an inventory;
receiving, at the computing device, loadout data to define a loadout that includes a plurality of inventory item slots to organize/group a set of items in the inventory, each inventory item slot of the plurality of inventory item slots specifying a type of item to be associated with the inventory item slot, the loadout associated with the user profile;
receiving, at the computing device, item data for one or more items in the inventory;
generating, on the computing device, an item record that is stored in a memory of the computing device, the item record generated using received item data;
receiving, at the computing device, input designating at least one item record to be associated with at least one inventory item slot of the loadout, the item record representing an item of the type specified by the inventory item slot; and
rendering, on a display, a graphical representation of the loadout, including the plurality of inventory item slots and associated item records.

20. The computer-readable storage medium of claim 19, further comprising:
receiving, over a network to which the computing device is coupled, an offer pertaining to an inventory item slot, the offer being an offer to sell an item of the type specified by the inventory item slot; and
presenting the offer to the user managing the inventory.
